(19) United States
(12) Patent Application Publication
(10) Pub. No.: US 2009/0208716 A1
(43) Pub. Date: Aug. 20, 2009

(54) Novel Composite Chemical Conversion Coating Film, Multiple Layered Coating Film Using the Same and Process for Forming Multiple Layered Coating Film

(76) Inventors: Toshio Kaneko, Osaka (JP); Satoshi Okamoto, Osaka (JP); Masanobu Futsuhara, Tokyo (JP); Makoto Doi, Osaka (JP); Eisaku Okada, Aichi (JP)

Correspondence Address: WENDEROTH, LIND & PONACK, L.L.P., 1030 15th Street, N.W.,, Suite 400 East, Washington, DC, 20005-1503, US

(21) Appl. No.: 12/224,563

(22) PCT Filed: Mar. 5, 2007
(86) PCT No.: PCT/JP2007/054197

§ 371 Date: Jan. 9, 2009

(30) Foreign Application Priority Data
Mar. 7, 2006 (JP) 2006-061381
Mar. 7, 2006 (JP) 2006-061387

(51) Int. Cl. B32B 7/02; C25D 5/10; B32B 15/04; B32B 27/06

(52) U.S. Cl. 428/215; 205/170; 428/469; 428/336; 428/341; 428/335

(57) ABSTRACT

The present invention relates to a composite chemical conversion coating film containing a crystalline continuous coating film that is formed on a metal substrate. The present invention also relates to a process for forming a multiple layered coating film including (A) the first step of immersing an untreated metal substrate in an aqueous solution containing nitrate of a rare earth metal and forming a crystalline continuous coating film containing a rare earth metal compound with a deposition amount of 1 mg/m² at lower limit and 110 mg/m² at upper limit by cathode electrolysis and (B) the second step of coating an electrodeposition coating composition containing an organic acid or inorganic acid salt of a rare earth metal by cathode electrodeposition. According to the present invention, provided is a multiple layered coating film that forms extremely less amount of a composite chemical conversion coating film and an electrodeposition coating film in order in comparison with a pretreatment step and a cationic electrodeposition coating step by a conventional chemical coating solution and an electrodeposition coating composition; that is, a novel composite chemical conversion coating film with high economic efficiency and environmental conservation property is provided by expressing superior adhesion to a coating film and corrosion resistance equal to or more than a conventional step.

### TECHNICAL FIELD

The present invention relates to a multiple layered coating film containing a coating-predisposed (pretreated) coating film and an electrodeposition coating film suitable for a metal material, in particular, an untreated cold-rolled steel plate. Further, the present invention relates to a process for forming a multiple layered coating film containing the first and second steps suitable for a metal material, in particular, an untreated cold-rolled steel plate.

### BACKGROUND OF THE INVENTION

An automobile body is manufactured to be a product by converting metal materials such as a cold-rolled steel plate or a galvanized steel plate to molded articles, then coating them and carrying out assembly and the like. An anticorrosion treatment such as zinc phosphate chemical conversion has been conventionally carried out for the metal molded articles at a coating step in order to provide adhesion property and the like for substrate electrodeposition coating film at first.

Further, an electrodeposition coating composition is superior in corrosion resistance and throwing power and can form an uniform coating film; therefore, it is widely used, centering on the automobile body and primer for parts. However, although a conventional cationic electrodeposition coating composition can express adequate corrosion resistance for a material to which pretreatment such as zinc phosphate has been perfectly carried out, the securement of corrosion resistance has been difficult for a material to which the pretreatment was insufficient.

In particular, since conventional zinc phosphate treatment requires a lot of deposition amount per a unit area in order to obtain adequate substrate corrosion resistance effect, it is not economical and since it precipitates a lot of sludge, there has been a problem that an adverse effect is given on environmental conservation.

Further, as an electrodeposition coating composition, there are necessities that coating capable of securing corrosion resistance for a material for which pretreatment is inadequate is designed, environmental conservation is considered by combination with an appropriate pretreatment method, and an economical substrate anticorrosion system is constituted.

Then, Japanese Kokai Publication Hei-9 (1997)-249990 and Japanese Kokai Publication 2000-64090 provide an effective pretreatment method applied for the coating substrate treatment of a metal material by which electrolysis is carried out in an aqueous solution, which contains 0.05 g/L or more of at least one of rare earth metal ion, sulfuric ion and zinc ion selected from the group consisting of yttrium (Y) ion, neodymium (Nd) ion, samarium (Sm) ion and praseodymium (Pr) ion, using metal to be treated as a cathode.

Further, Japanese Kokai Publication Hei-8 (1996)-53637 provides a cathode electrodeposition coating composition obtained by dispersing a hydrophilic film-forming resin having a cationic group and a curing agent in an aqueous medium containing a neutralizing agent, wherein at least one phosphomolybdate selected from aluminum salt, calcium salt and zinc salt is contained by 0.1 to 20% by weight based on coating solid content and a cerium compound is contained by 0.01 to 2.0% by weight as a metal. It is a method enabling the improvement of corrosion resistance for a cold-rolled steel plate whose surface is untreated.

However, in the above-described patent literatures, an combination of the pretreatment method with the coating process by an electrodeposition coating composition respectively described could not achieve a level in which substrate adherence equal to or more than a conventional chemical conversion by phosphate is expressed and practical corrosion resistance after electrodeposition coating, in particular, a level in which substrate anticorrosion performance for use in automobiles is adequately expressed. Further, the improvement of economical efficiency by the reduction of a deposition amount per unit area of the treated coating film obtained and environmental conservation property has been also further required.

### SUMMARY OF THE INVENTION

Considering the above-described current circumstances, an object of the present invention to provide a novel coating film having adhesion to the coating film and corrosion resistance equal to or more than a conventional method in spite of being a coating film formed by an extremely small amount in comparison with an amount of a chemical conversion coating film obtained by conventional pretreatment.

Further, an object of the present invention to provide a process for forming a multiple layered coating film that forms a coating film with an extremely less amount in comparison with a pretreatment step and a cationic electrodeposition coating step by conventional chemical solution and an electrodeposition coating composition and an electrodeposition coating film, thereby, to provide a novel substrate anticorrosion process with high economical efficiency and environmental conservation property by expressing superior adhesion to the coating film and corrosion resistance equal to or more than a conventional step.

The present invention provides a crystalline continuous coating film containing a rare earth metal compound that is formed on a metal substrate. The present invention provides also a composite chemical conversion coating film in which an amorphous rare earth metal compound exists on a crystalline continuous coating film containing a rare earth metal compound that is formed on a metal substrate. The present invention provides further a composite chemical conversion coating film containing a crystalline continuous coating film with a film thickness of 3 to 200 nm which is composed of a rare earth metal compound, which is formed on a metal substrate. Further, the present invention provides also a composite chemical conversion coating film containing a crystalline continuous coating film containing a rare earth metal compound with a coating film amount of 1 mg/m² at lower limit and 110 mg/m² at upper limit, which is formed on a metal substrate.

In order to preferably carry out the present invention, it may be preferable that the above-described crystalline continuous coating film is a compound containing at least one of rare earth metal selected from the group consisting of cerium (Ce), yttrium (Y), neodymium (Nd), samarium (Sm) and praseodymium (Pr).

As the further other aspect of the present invention, there is a multiple layered coating film in which an organic resin coating film with a film thickness of 5 to 50 μm is coated on the above-described composite chemical conversion coating film.

In order to preferably carry out the present invention, it may be preferable that the above-described organic resin coating film is an electrodeposition cured coating film by a cation modified epoxy resin and a blocked isocyanate curing agent as main components and further, the above-described organic resin coating film is an electrodeposition cured coating film further containing a pigment.

Further, the present invention provides a process for forming a multiple layered coating film including (A) first step of immersing an untreated metal substrate in an aqueous solution containing nitrate of a rare earth metal and forming a crystalline continuous coating film containing a rare earth metal compound with a deposition amount of 1 mg/m² at lower limit and 110 mg/m² at upper limit by cathode electrolysis and (B) second step of coating an electrodeposition coating composition containing an organic acid or inorganic acid salt of a rare earth metal by cathode electrodeposition.

It has been found in the above-described first step that the crystalline continuous coating film from (A) an aqueous solution containing a nitric acid salt of a rare earth metal compound can be extremely preferentially deposited on the above-described metal substrate at a deposition amount of 1 mg/m² at lower limit and 110 mg/m² at upper limit, by usually adjusting a bath temperature at 15 to 35° C. and then carrying out cathode electrolysis at a loading voltage of 1 to 20 V and preferably 1 to 10 V.

As described above, in the present invention, the composite chemical conversion coating film derived from a rare earth metal compound is characterized by being designed so as to be compositively formed at the two stages of the first and second steps.

As described above, since the film thickness of the composite chemical conversion coating film of the present invention is very small, it has advantage that the amount of a treating agent is extremely small in comparison with a conventional substrate anticorrosion step of an automobile. Further, the composite chemical conversion coating film of the present invention has advantage that it can be formed without the generation of sludge. Further, since the composite chemical conversion coating film of the present invention is a continuous dense composite chemical conversion film of a rare earth metal compound formed on a metal substrate, it can provide superior adhesion to the coating film and anticorrosion property equal to or more than conventional pretreatment/electrodeposition steps nevertheless it is a very thin coating film in comparison with a conventional chemical conversion coating film.

Further, as described above, the process for forming a coating film of the present invention is a process for forming a multiple layered coating film, comprising the first step of immersing an untreated metal substrate in an aqueous solution containing (A) nitrate of rare earth metal, and forming a crystalline continuous coating film according to claim 4 comprising a rare earth metal compound with a deposition amount of 1 mg/m² at lower limit and 110 mg/m² at upper limit by cathode electrolysis, and

the second step of coating an electrodeposition coating composition containing (B) organic acid or inorganic acid salt of a rare earth metal by cathode electrodeposition. A multiple layered coating film obtained by the process of the present invention has advantage that superior anticorrosion property can be achieved even if an amount of the treating agent is extremely small in comparison with the conventional substrate anticorrosion step of an automobile. Further, the process of the present invention is a breakthrough treatment process that does not accompany the generation of sludge. Further, the process of the present invention can express a portion of chemical conversion function by an electrodeposition coating treatment using the electrodeposition coating composition. Accordingly, the multiple layered coating film by the composite chemical conversion coating film superior in adhesion to the coating film and corrosion resistance equal to or more than conventional pretreatment/electrodeposition steps and an electrodeposition coating film can be obtained by the continuous process of the first and second steps.

### BRIEF DESCRIPTION OF THE DRAWINGS

FIG. 1 is a TEM photo (coating film portion is shown by an arrow mark, film thickness: 8 nm) of a crystalline continuous coating film after the first step of the present invention;

FIG. 2 is a TEM photo (coating film portion is shown by an arrow mark, film thickness: 12 nm) of a composite chemical conversion coating film after the first/second steps of the present invention;

FIG. 3 is a TEM photo and an EDX observation result (upper stage) of the surface portion of a substrate after the first step of the present invention and the TEM photo and EDX observation result (lower stage) of a multiple layered coating film after the first/second steps; and,

FIG. 4 is a high magnification photo by TEM of a multiple layered coating film after the first/second steps of the present invention.

### DETAILED DESCRIPTION OF THE PREFERRED EMBODIMENTS

The composite chemical conversion coating film of the present invention may be dense crystalline continuous coating film by a rare earth metal compound. But it is difficult that the crystallized rare earth metal compound is continuously, uniformly and densely formed on a metal substrate. In the present invention, a layer of a crystalline rare earth metal compound is preliminarily formed and gaps between crystals caused by its crystalline are filled with an amorphous rare earth metal compound to be complexified. Accordingly, since the above-described amorphous rare earth metal compound enters into the gaps of the above-described crystalline coating film, the film becomes a continuous, uniform and dense film, and anticorrosion property is thus improved. The crystalline coating film of the above-described rare earth metal compound can be formed by immersing an untreated metal substrate in an aqueous solution containing nitrate of a rare earth metal and by cathode electrolysis. The composite chemical conversion coating film of the present invention is formed by filling the gaps formed between the crystals of the above-described crystalline coating film, with the above-described amorphous rare earth metal compound. The amorphous rare earth metal compound existing on the crystalline continuous coating film can be formed by various methods. A method by electrodeposition coating described later may be preferable. Of course, other than such as method, it can be formed by a method of forming a crystalline coating film containing the rare earth metal compound and then coating or spraying the amorphous rare earth metal compound. However, since a film thickness tends to be very large by such a method, electrodeposition coating may be preferable.

In the present invention, the amorphous rare earth metal compound existing on the crystalline continuous coating film is formed by utilizing phenomenon such that a rare earth metal ion is previously deposited at cathode electrodeposition by introducing an organic acid salt or inorganic acid salt of a rare earth metal in a cathode electrodeposition coating composition, in particular. Further, when cathode electrodeposition is continued, a resin component of the electrodeposition coating composition is deposited on the cathode. In the present invention, the amorphous rare earth metal compound is deposited between the gaps of a coating film of the crystalline rare earth metal compound, and thereby, a layer in which the crystalline rare earth metal compound and the amorphous rare earth metal compound exist in mixture forms a composite chemical conversion coating film. It is integrated with a resin layer deposited thereafter to form a multiple layered coating film.

Accordingly, in the present invention, by using the above-described process, the composite chemical conversion coating film is preferably formed by a process including (A) the first step of immersing an untreated metal substrate in an aqueous solution containing the nitrate of rare earth metal and forming crystalline continuous coating film containing a rare earth metal compound with a deposition amount of 1 mg/m² at lower limit and 110 mg/m² at upper limit by cathode electrolysis and (B) the second step of coating an electrodeposition coating composition containing the organic acid salts or inorganic acid salts of rare earth metals by cathode electrodeposition. In the second step (B), since rare earth metal ions prepared from the organic acid salts or inorganic acid salts of rare earth metals in the electrodeposition coating composition have higher in deposition property than a resin vehicle component or a pigment has, they deposit on the crystalline continuous coating film of the rare earth metal compound preferentially formed in the first step (A) as the amorphous rare earth metal compound and form a composite dense continuous chemical conversion coating film by the rare earth metal compound by filling gaps of the above-described crystalline coating film. Accordingly, nevertheless the above-described coating film is very thin chemical conversion coating film in comparison with a conventional chemical conversion coating film, it can have superior adhesion property and anticorrosion property equal to or more than the conventional chemical conversion level. Further, the composite chemical conversion coating film is formed by the second step (B), and an organic resin coating film is simultaneously formed on the composite chemical conversion coating film.

The composite chemical conversion coating film of the present invention is described in detail. A film thickness of the crystalline continuous coating film by the above-described rare earth metal compound is preferably 3 to 200 nm and more preferably 5 to 100 nm in the composite chemical conversion coating film (a layer in which the crystalline and amorphous rare earth metal compounds exist in mixture) of the present invention. When the film thickness of the above-described crystalline continuous coating film is less than 3 nm, an amount of the coating film may be inadequate and the adhesion property of the coating film may be lowered. In this case, anticorrosion property may not be adequately obtained. When the film thickness of the above-described crystalline continuous coating film exceeds 200 nm, a roughness degree of a substrate surface after the treatment may be enlarged. In this case, shielding may be difficult even by overcoating of an electrodeposition coating film and skin defect of the multiple layered coating film may be induced and the appearance of the coating film may be deteriorated.

Further, the crystalline continuous coating film by the above-described rare earth metal compound is preferably a coating film amount of 1 mg/m² at lower limit and 110 mg/m² at upper limit, and more preferably 6 mg/m² at lower limit and 55 mg/m² at upper limit. When the coating film amount of the above-described crystalline continuous coating film is less than 1 mg/m², the anticorrosion property may not be adequately obtained. Further, when it exceeds 110 mg/m², a roughness degree of a substrate surface after the treatment may be enlarged. In this case, shielding may be difficult even by overcoating of an electrodeposition coating film and skin defect of the multiple layered coating film may be induced and the appearance of the coating film may be deteriorated.

As described above, it is requisite that the crystalline continuous coating film is formed from a rare earth metal compound. As the above-described rare earth metal compound, a compound containing at least one of rare earth metal selected from the group consisting of cerium (Ce), yttrium (Y), neodymium (Nd), samarium (Sm) and praseodymium (Pr) may be preferable.

It has been found in the above-described first step (A) that the crystalline continuous coating film from an aqueous solution mainly containing a nitric acid salt of a rare earth metal compound can be extremely preferentially deposited on the above-described metal substrate, by usually adjusting a bath temperature at 15 to 35° C. and carrying out cathode electrolysis at a loading voltage of 1 to 20 V and preferably 1 to 10 V.

At that time, when the loading voltage is less than 1 V, deposition of the above-described composite metal hydroxide is inadequate. When the loading voltage exceeds 20 V, the generation of a hydrogen gas by the electrolysis of water rather than the deposition of the above-described composite metal hydroxide is remarkable; therefore, it is not preferable because it acts counter to the purpose of forming a crystalline continuous coating film.

A power distribution time is 10 to 300 sec and preferably 30 to 180 sec. When the treatment time is shorter than 10 sec, a coating film is not produced or even if it is produced, a thickness is inadequate. When the treatment time is longer than 300 sec, appearance defect that is called as lusterless burnt spot or scorched deposit is sometimes generated. Further, since excessive treatment time extremely lowers productivity, it is not preferable.

Examples of an untreated metal material to which the above-described process for forming a coating film is applied include a cold-rolled steel plate, high-tension steel, high-tensile steel, cast iron, zinc and galvanized steel, aluminum and aluminum alloy and the like. The material specifically remarkable in an anticorrosion effect is a cold-rolled steel plate.

(A) An untreated metal substrate is immersed in an aqueous solution containing the nitrate of a rare earth metal compound and a deposition amount containing the rare earth metal compound is set at 1 mg/m² at lower limit and 110 mg/m² at upper limit, and preferably 6 mg/m² at lower limit and 55 mg/m² at upper limit by cathode electrolysis. Thereby, a specifically high anticorrosion coating film can be formed. When the above-described deposition amount is less than 1 mg/m², substrate adhesion property by the formed coating film is lowered; therefore, requisite anticorrosion property is not expressed. On the other hand, when the above-described deposition amount exceeds 110 mg/m², the surface smoothness of the coating film is damaged; therefore, it is not preferable because appearance after forming an electrodeposition coating film is occasionally lowered.

Further, as (B) the above-described second step, while keeping a bath temperature of the above-described electrodeposition coating composition at 15 to 35° C., loading voltage is set at 50 to 450 V and preferably 100 to 400 V in order to mainly carry out cathode electrodeposition coating, and thereby, deposition (amorphous rare earth metal compound) mainly from an organic acid salt or inorganic acid salt of a rare earth metal is preferentially deposited. Then, a base resin having a cationic group that is a coating vehicle, a curing agent and a pigment can be deposited. When the above-described loading voltage is less than 50 V, the deposition property of the vehicle component of the above-described electrodeposition coating composition may be insufficient. On the other hand, when the loading voltage exceeds 450 V, the above-described vehicle component is deposited exceeding an appropriate amount, and as a result, it is not preferable because film appearance that cannot be practically used may be exhibited.

A power distribution time is 30 to 300 sec, and preferably 30 to 180 sec. When the power distribution time is shorter than 30 sec, an electrodeposition coating film is not produced, or even if it is produced, corrosion resistance may be inferior because a thickness is inadequate. Further, since the excessive power distribution time exceeding 300 sec extremely lowers productivity, it is not preferable.

The multiple layered coating film of another aspect of the present invention is formed by the above-described second step (B) as a result. It is requisite that the organic resin coating film is coated at a film thickness of 5 to 50 μm and preferably 10 to 30 μm on the above-described composite chemical conversion coating film. When the film thickness of the above-described organic resin coating film is less than 5 μm, the shielding property of the coating film is lowered and as a result, and anticorrosion property may be inadequate. On the other hand, when the film thickness exceeds 50 μm, it is not economically preferable.

The mechanism that the crystalline continuous coating film is obtained by the above-described first step (A) is considered as below. Chemical species in a bath such as dissolved oxygen, hydrogen ion and water are reduced on the metal surface of a cathode and hydroxide ion (OH⁻) is produced. The hydroxide ion reacts firstly with a rare earth metal ion nearby the above-described metal surface, and thereby the deposit of the hydroxide of the rare earth metal is produced to be deposited on the metal surface as a coating film.

However, (A) an untreated metal substrate is immersed in an aqueous solution containing the nitrate of a rare earth metal and the coating film prepared by the cathode electrolysis of the nitrates of rare earth metals has crystallinity, but the present step alone cannot attain objective conventional adhesion property at a chemical conversion level and anticorrosion property level after electrodeposition coating.

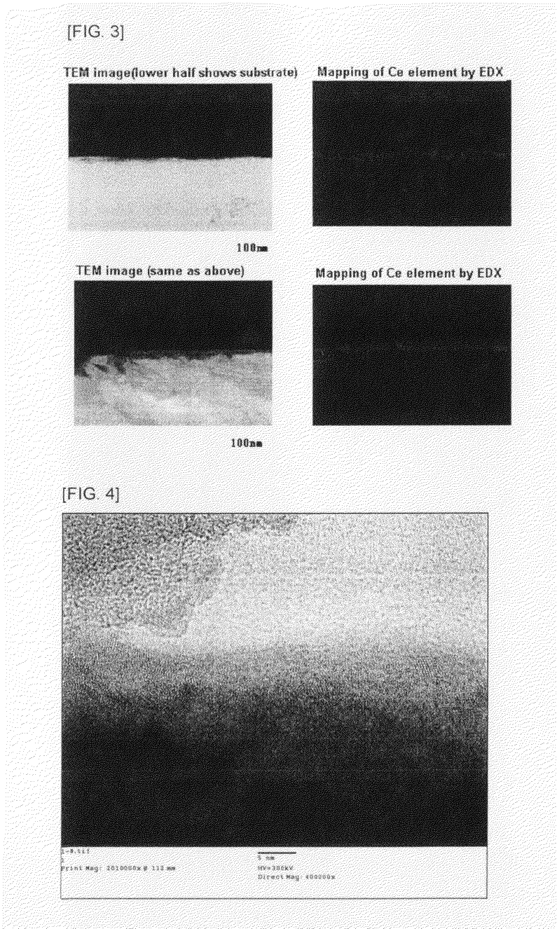

The rare earth metal ion prepared from the organic acid or inorganic acid salt of rare earth metal from the electrodeposition coating composition by the next second step (B) has higher deposition property than the resin vehicle component and pigment; therefore, it is preferentially deposited on the above-described crystalline continuous coating film formed in the first step (A), as an amorphous rare earth metal compound. As a result, it fills gaps of the above-described crystalline coating film obtained in the above-described first step (A) as shown in FIG. 3 (upper stage) and then, a composite dense continuous chemical conversion coating film as shown in FIG. 3 (lower stage), that is, a crystalline continuous coating film by the rare earth metal compound and the chemical conversion coating film containing the amorphous rare earth metal compound are formed. Accordingly, nevertheless the above-described coating film is a very thin chemical conversion coating film, it is deduced that it exhibits superior adhesion property and anticorrosion property after electrodeposition coating equal to or more than objective conventional chemical conversion level that has not been conventionally observed.

In one aspect of the above-described process for forming a novel composite chemical conversion coating film of the present invention, the dense composite chemical conversion coating film with a very small film thickness at the two stages of the first and second steps is formed as a composite chemical conversion coating film derived from the rare earth metal compound; therefore, superior anticorrosion property is obtained although the amount of a treating agent is negligibly small in comparison with the conventional substrate anticorrosion step of an automobile. Further, the process of the present invention does not generate sludge and is a periodical treatment process. Further, the process of the present invention can express the portion of chemical conversion function by electrodeposition coating treatment using the electrodeposition coating composition. Accordingly, the multiple layered coating film by the composite chemical conversion coating film superior in adhesion to the coating film and corrosion resistance equal to or more than conventional pretreatment/electrodeposition steps and an electrodeposition coating film can be obtained by the continuous process of the first and second steps.

In one aspect of the above-described process for forming the novel composite chemical conversion coating film of the present invention, the above-described aqueous solution used in the first step in which (A) the first step of immersing an untreated metal substrate in an aqueous solution containing the nitrate of a rare metal and forming a crystalline continuous coating film consisting of a rare earth metal compound by cathode electrolysis is called as “an aqueous solution for the first step”. Hereinafter, such an aqueous solution for the first step will be specifically described. The above-described aqueous solution for the first step contains 0.05 to 5% by weight and preferably 0.1 to 3% by weight of nitrate of a rare earth metals converted to the rare earth metal. These nitrates are water-soluble or water dispersible, and a predetermined amount is easily dissolved or dispersed in pure water to be able to be supplied for carrying out the present invention. When it is less than 0.05% by weight, corrosion resistance based on adequate substrate adhesion property may not be occasionally obtained. On the other hand, when it exceeds 5% by weight, the dispersion stability of the components of the electrodeposition coating composition and the smoothness of the chemical conversion coating film may be lowered and as a result, skin defect after electrodeposition may be occasionally induced.

Further, the nitrate of the rare earth metal are nitrate containing at least one of rare earth metal selected from the group consisting of cerium (Ce), yttrium (Y), neodymium (Nd), samarium (Sm) and praseodymium (Pr). Among these, the particularly preferable nitrate of the rare earth metal is cerium nitrate (Ce) and neodymium nitrate (Nd).

Further, it may be preferable that a pH of the aqueous solution for the first step is adjusted within the range of 4 to 7 and preferably 4.5 to 6.5. When the above-described pH is less than 4, electrolysis deposition efficiency and coating film appearance may be lowered. On the other hand, the above-described pH exceeds 7, the stability of a rare earth metal ion in the composition tends to be lowered. As chemicals used for adjustment of pH, an inorganic acid such as nitric acid or organic acid such as formic acid and acetic acid may be added when pH is high, and an organic base such as amine or an inorganic base such as ammonia and sodium hydroxide may be added when pH is low. Added chemicals are not limited.

The appropriate liquid conductivity of the above-described aqueous solution for the first step is 1 to 100 mS/cm. When the conductivity is less than 1 mS/cm, the treatment may be inadequate and the throwing power of the composite chemical conversion coating film and an electrodeposition coating film may be insufficient. On the other hand, when it exceeds 100 mS/cm, it is not preferable because appearance defect of the composite chemical conversion coating film may be caused.

Then, the electrodeposition coating composition used in the second step of the two stages step that is the process for forming the above-described composite chemical conversion coating film is described in details. The above-described electrodeposition coating composition contains an organic acid or inorganic acid salt of a rare earth metal, and further contains a base resin having a cationic group, a curing agent and a pigment as main components. Firstly, the organic acid or inorganic acid salt of the rare earth metal includes at least one of rare earth metals selected from the group consisting of cerium (Ce), yttrium (Y), neodymium (Nd), samarium (Sm) and praseodymium (Pr), and includes an organic acid or inorganic acid salt compound including at least one selected from acetic acid, formic acid, lactic acid, sulfamic acid or hypophosphorous acid. Among these, the particularly preferable salt compound is a salt compound by acetic acid, formic acid or sulfamic acid.

Examples of the preferable organic acid salt or inorganic acid salt of a rare earth metal include cerium acetate, yttrium acetate, neodymium acetate, samarium acetate, praseodymium acetate, cerium formate, yttrium formate, neodymium formate, samarium formate, praseodymium formate, cerium lactate, neodymium lactate, cerium sulfamate, neodymium sulfamate, yttrium sulfamate, samarium sulfamate, praseodymium sulfamate, cerium hypophosphite, neodymium hypophosphite, yttrium hypophosphite, samarium hypophosphite, praseodymium hypophosphite, and the like. Among these, particularly preferable rare earth metals may be cerium (Ce) and neodymium (Nd).

The electrodeposition coating composition containing the above-described water-soluble salt of a rare earth metal contains 0.005 to 2% by weight and preferably 0.01 to 1% by weight of a rare earth metal compound converted to a rare earth metal based on the coating solid content. When the content in the coating solid content of the organic acid salt or inorganic acid salt of the rare earth metal is less than 0.005% by weight, corrosion resistance based on adequate substrate adhesion property may not be occasionally obtained, and when it exceeds 2% by weight, the dispersion stability of the components of the electrodeposition coating composition, the smoothness of the electrodeposition coating film and water resistance may be occasionally lowered.

It is desirable that a deposition amount of the rare earth metal compound from the electrodeposition coating composition at the second step is within the range of 0.5 to 10 mg/m² and preferably 1 to 5 mg/m². When it is less than 0.5 mg/m², it cannot adequately fill gaps between the above-described crystalline coating film for the crystalline continuous coating film previously obtained at the first step by cathode electrolysis, and it is deduced that denseness and continuousness of the composite coating film may be lack. As a result, adhesion property and corrosion resistance are insufficient. Further, when the above-described deposition amount exceeds 10 mg/m², it is not preferable because the dispersion stability of the components of the electrodeposition coating composition, the smoothness of the electrodeposition coating film and water resistance may be occasionally lowered.

Control of the above-described preferable deposition amount can be enabled by the above-described preferable electrolysis condition.

Introduction process of the above-described organic acid salt or inorganic acid salt of the rare earth metal to a composition for the electrodeposition coating composition is not specifically limited, and can be carried out similarly as a usual pigment dispersion process. For example, a rare earth metal compound is preliminarily dispersed using a dispersion resin to prepare dispersion paste and it can be compounded. Alternatively, after preparation of a resin emulsion for coating, it can be dispersed or compounded as it is or after dissolution. A pigment dispersion resin includes a general resin for a cationic electrodeposition coating composition (epoxy sulfonium salt type resin, epoxy quaternary ammonium salt type resin, epoxy tertiary ammonium salt type resin, acryl quaternary ammonium salt type resin, and the like).

The base resin having a cationic group used for the electrodeposition coating composition of the present invention is a cation modified epoxy resin that is obtained by modifying oxirane rings in a main chain of the resin with an organic amine compound. In general, the cationic modified epoxy resin is produced by opening oxirane rings in a molecule of a starting raw material resin by a reaction with amines such as primary amine, secondary amine or tertiary amine. Typical examples of the starting raw material resin include a polyphenol polyglycidyl ether type epoxy resin that is a reaction product of polycyclic phenol compounds such as bisphenol A, bisphenol F, bisphenol S, phenol novolac and cresol novolac, with epichlorohydrin. Further, as an example of other starting raw material resin includes an oxazolidone ring-containing epoxy resin described in Japanese Kokai Publication Hei-5 (1993)-306327. The epoxy resin is obtained by a reaction of epichlorohydrin with a diisocyanate compound or a bisurethane compound that is obtained by blocking the NCO groups of the diisocyanate compound with lower alcohols such as methanol and ethanol.

The above-described starting raw material resin can be used by extending chains by a bifunctional polyester polyol, polyether polyol, bisphenols, dibasic carboxylic acid and the like before the ring opening reaction of the oxirane rings by amines.

Further, similarly, for the purpose of adjustment of a molecular weight or an amine equivalent and improvement of thermal flow property, and the like, monohydroxy compounds such as 2-ethylhexanol, nonylphenol, ethylene glycol mono-2-ethylhexyl ether and propylene glycol mono-2-ethylhexyl ether can be added for partial epoxy rings to be used before the ring opening reaction of epoxy rings by amines.

Examples of amines that can be used for opening the oxirane ring and introducing an amino group include butylamine, octylamine, diethylamine, dibutylamine, methylbutylamine, monoethanolamine, diethanolamine, N-methylethanolamine, primary, secondary or tertiary amic acid salts such as triethylamic acid salt and N,N-dimethylethanolamic acid salt. Further, ketimine block primary amino group-containing secondary amine such as aminoethylethanolamine methyl isobutyl ketimine can be also used. It is necessary that these amines are reacted by at least equivalent for the oxirane rings in order to open the all rings of the oxirane rings.

The number average molecular weight of the above-described cation modified epoxy resin may be in the range of 1500 to 5000 and preferably 1600 to 3000. When the number average molecular weight is less than 1500, the physical properties such as solvent resistance and corrosion resistance of a cured forming coating film may be occasionally inferior. On the other hand, when it exceeds 5000, the viscosity control of a resin solution is difficult, and synthesis may be not only difficult but also handling on operation such as dispersion by emulsification of the obtained may be occasionally difficult. Further, since it is high viscosity, flow property at heating and curing may be poor, the appearance of the coating film may be damaged remarkably.

The molecular design of the above-described cation modified epoxy resin may be preferably carried out so that a hydroxyl value is in the range of 50 to 250. When the hydroxyl value is less than 50, the curing defect of the coating film may be caused. On the other hand, when it exceeds 250, excessive hydroxyl group may remain in the coating film after curing. As a result, water resistance may be occasionally lowered.

Further, the molecular design of the above-described cation modified epoxy resin may be preferably carried out so that an amine value is in the range of 40 to 150. When the amine value is less than 40, defect of dispersion by emulsification in an aqueous medium by the above-described neutralization of acid may be caused. On the other hand, when it exceeds 150, excessive amino groups may remain in the coating film after curing. As a result, water resistance may be occasionally lowered.

The curing agent for use in the electrodeposition coating composition in the present invention may be any kind so far as it can cure respective resin components at heating. Among these, blocked polyisocyanate preferable as the curing agent of the electrodeposition coating composition is recommended. Examples of polyisocyanate that is the raw material of the above-described blocked polyisocyanate include aliphatic diisocyanates such as hexamethylene diisocyanate (including trimer), tetramethylene diisocyanate and trimethylhexamethylene diisocyanate; alicyclic polyisocyanates such as isophorone diisocyanate and 4,4′-methylenebis(cyclohexyl isocyanate); aromatic diisocyanates such as 4,4′-diphenylmethane diisocyanate, tolylene diisocyanate and xylylene diisocyanate, etc. The above-described blocked polyisocyanates can be obtained by blocking these with these suitable blocking agents.

Examples of the above-described blocking agent preferably include monovalent alkyl or aromatic alcohols such as n-butanol, n-hexyl alcohol, 2-ethylhexanol, lauryl alcohol, phenol carbinol and methylphenyl carbinol; cellosolves such as ethylene glycol monohexyl ether and ethylene glycol mono-2-ethylhexyl ether; polyether type both terminal diols such as polyethylene glycol, polypropylene glycol and polytetramethylene ether glycol phenol; polyester type both terminal polyols that are obtained by reacting diols such as ethylene glycol, propylene glycol and 1,4-butane diol with dicarboxylic acids such as oxalic acid, succinic acid, adipic acid, suberic acid and sebasic acid; phenols such as para-t-butylphenol and cresol; oximes such as dimethyl ketoxime, methylethyl ketoxime, methyl isobutyl ketoxime, methyl amyl ketoxime and cyclohexanone oxime; and lactams represented by ε-caprolactam and γ-butyrolactam.

It is desirable that the above-described blocked polyisocyanate is preliminarily blocked by using a blocking agent alone or a plurality of blocking agents. Its blocking rate is preferably 100% for securing the storage stability of coating unless a modification reaction with the above-described respective resin components is carried out.

The compounding ratio of the above-described blocked polyisocyanate to the base resin having the above-described cationic group differs depending on a crosslinking degree required for the utilization purpose of a cured coating film. It may be preferably in the range of 15 to 40% by weight as a solid content, considering the physical properties of a coating film and the coating adaptability of an intermediate coating composition. When the compounding ratio is less than 15% by weight, the curing defect of the coating film may be caused and as a result, the physical properties of a coating film such as mechanical strength may be occasionally lowered. Further, poor appearance that the coating film may be affected by a coating film thinner at the coating of an intermediate coating composition may be occasionally induced. On the other hand, when it exceeds 40% by weight, curing may be excessive and poor physical properties of a coating film such as impact resistance may be occasionally caused. Further, plurality kinds of the blocked polyisocyanates may be used in combination depending on the physical properties of a coating film and the adjustment of a curing degree and a curing temperature.

The base resin having a cationic group is prepared by neutralizing an amino group in the resin with an appropriate amount of inorganic acids such as hydrochloric acid, nitric acid and hypophosphoric acid or organic acids such as formic acid, acetic acid, lactic acid, sulfamic acid and acetylglycinic acid and dispersing it in water by emulsification as an cationic emulsion. Further, at dispersion by emulsification, emulsion particles in which a curing agent is used as a core and the base resin is contained as a shell are formed.

A pigment may be further added in the electrodeposition coating composition used in the second step of the present invention. The pigment can be used without specific limitation so far as it is usually used for coating. Examples thereof includes coloring pigments such as carbon black, titanium dioxide and graphite; body pigments such as kaolin, aluminum silicate (clay), talc, calcium carbonate or inorganic colloid (silica sol, alumina sol, titanium sol, zirconia sol and the like); heavy metal free type anticorrosion pigments such as phosphoric acid pigment (aluminum phosphomolybdate, zinc (poly)phosphate, calcium phosphate and the like) and molybdic acid pigment (aluminum phosphomolybdate, zinc phosphomolybdate and the like).

Among these pigments, particularly important pigments are titanium dioxide, carbon black, aluminum silicate (clay), silica, aluminum phosphomolybdate and zinc polyphosphate. In particular, since titanium dioxide and carbon black has higher covering property as a coloring pigment and are inexpensive, they are most suitable for an electrodeposition coating film.

Further, the pigment can be used alone, but plurality kinds are generally used in accordance with its purpose.

A weight ratio {P/(P+V)} (hereinafter, called as PWC) of the pigment based on the total weight (P+V) of the pigment (P) and a solid resin content (V) contained in the electrodeposition coating composition may be preferably in the range of 5 to 30% by weight. When the weight ratio is less than 5% by weight, the blocking property of corrosion factors such as water and oxygen for coating film may be excessively lowered because of insufficient pigment; therefore, weather resistance and corrosion resistance at practical use level may not be occasionally expressed. However, when such trouble does not occur, a pigment concentration shall be nearly zero, and an electrodeposition coating composition that is clear or close to clear may be prepared to be supplied for the present invention. On the other hand, when the weight ratio exceeds 30% by weight, viscosity at curing may be increased because of excessive pigment, flow property may be lowered and coating film appearance may be extremely deteriorated occasionally; therefore attention shall be paid to it. The solid resin content (V) shows the total solid content of all resin binders composing the electrodeposition coating film including the above base resin that is a main resin of an aqueous coating composition, a curing agent, and a pigment dispersing resin.

The electrodeposition coating composition may be adjusted so that the concentration of a total solid content is in the range of 5 to 40% by weight and preferably 10 to 25% by weight. An aqueous medium (water alone or a mixture of water and a hydrophilic organic solvent) is used for the adjustment of the concentration of the total solid content.

Further, a small amount of an additive may be introduced in the electrodeposition coating composition. Examples of the additive include an ultraviolet absorbent, an antioxidant, a surfactant, a coating film surface-smoothing agent, a curing agent (organic tin compound such as dibutyltin oxide, dioctyltin dilaurate, dibutyltin dilaurate, dioctyltin dilaurate, dibutyltin diacetate, dibutyltin dibenzoate or dioctyltin dibenzoate) and the like.

An electrodeposition cured coating film with a high crosslinking degree can be obtained by carrying out a curing reaction at 120 to 200° C. and preferably 140 to 180° C. after the electrodeposition coating. When it exceeds 200° C., the coating film may be excessively hard and fragile. On the other hand, when it is less than 120° C., it is not preferable because curing may be insufficient and the physical properties of a coating film such as solvent resistance and film strength may be lowered.

### EXAMPLES

The present invention is more specifically illustrated below according to Examples, but the present invention is not limited only to these Examples.

### Preparation Example 1

### Preparation Example of Aqueous Solution of Rare Earth Metal Salt for the First Step

After a predetermined amount of the carbonate or hydroxide of a rare earth metal was dispersed in ion exchange water in a reaction vessel equipped with a stirrer, a cooling tube and a thermometer, acids such as nitric acid or acetic acid being the counter ion of the metal salt were added to be dissolved while heating and stirring and the aqueous solution of rare earth metal salt with a metal ion concentration of 5% was prepared. After the solution pH of the solution obtained was adjusted at 4 to 7 with an aqueous ammonia solution or an aqueous sodium hydroxide solution, a treating solution was prepared by diluting it to a predetermined concentration with ion exchanged water. The rare earth conversion coating solution, the acid species of the salt compound and the conductivity of the conversion coating solution that were applied to the test were shown in Tables 2 and 3 below.

### Preparation Example 2

### Production of Base Resin Having Cationic Group

2400 Parts of a bisphenol A type epoxy resin (trade name: DER-331J, manufactured by Dow Chemical Co.) having an epoxy equivalent weight of 188, 141 parts of methanol, 168 parts of methyl isobutyl ketone and 0.5 part of dibutyltin dilaurate were charged in a reaction vessel equipped with a stirrer, a decanter, a nitrogen-introducing tube, a thermometer and a dropping funnel, and the mixture was stirred at 40° C. to be uniformly dissolved. Then, when 320 parts of 2,4-/2,6-tolylene diisocyanate (mixture with a weight ratio of 80/20) was added dropwise thereto over 30 min, heat was generated and the mixture was raised to 70° C. 5 parts of N,N-dimethylbenzylamine was added thereto, and a temperature in the system was raised to 120° C. and the reaction was continued at 120° C. for 3 hours until an epoxy equivalent weight was 500, while distilling methanol off. Further, 644 parts of methyl isobutyl ketone, 341 parts of bisphenol A and 413 parts of 2-ethylhexanoic acid were added, a temperature in the system was kept at 120° C. and after a reaction was continued until an epoxy equivalent weight was 1070, then the mixture was cooled until a temperature in the system was 110° C. Next, a mixture of 241 parts of diethylenetriamine diketimine (methyl isobutyl ketone solution with a solid content of 73%) and 192 parts of N-methylethanolamine was added and the reaction was carried out at 110° C. for 1 hour to obtain a cation modified epoxy resin. The number average molecular weight of the resin was 2100, an amine value was 74 and a hydroxyl group value was 160. Further, it was confirmed from the measurement of infrared absorption spectrum and the like that it had an oxazolidone ring (absorption coefficient: 1750 cm⁻¹) in the resin.

### Preparation Example 3

### Production of Curing Agent for Electrodeposition Coating Composition

222 parts of isophorone diisocyanate was charged in a reaction vessel equipped with a stirrer, a nitrogen-introducing tube, a cooling tube and a thermometer and diluted with 56 parts of methyl isobutyl ketone, then 0.2 part of butyltin laurate was added and after a temperature was raised to 50° C., 17 parts of methyl ethyl ketoxime was added so that the temperature of the content did not exceed 70° C. After the reaction mixture was kept at 70° C. for 1 hour until the absorption of an isocyanate residual group was substantially extinguished by infrared absorption spectrum, the mixture was diluted with 43 parts of n-butanol to obtain an objective blocked isocyanate curing agent solution (solid content of 70%).

### Preparation Example 4

### Production of Pigment Dispersion Resin

710 parts of a bisphenol A type epoxy resin (trade name: EPON 829, manufactured by Shell Chemicals) with an epoxy equivalent weight of 198 and 289.6 parts of bisphenol A were charged in a reaction vessel equipped with a stirrer, a cooling tube, a nitrogen-introducing tube and a thermometer, a reaction was carried out at 150 to 160° C. for 1 hour under nitrogen atmosphere, and then, after cooling it to 120° C., 406.4 parts of the methyl isobutyl ketone solution (solid content of 95%) of half blocked tolylene diisocyanate modified with 2-ethylhexanol was added thereto. After the reaction mixture was kept at 110 to 120° C. for 1 hour, 1584.1 parts of ethylene glycol mono-n-butyl ether was added. Then, the mixture was cooled to 85 to 95° C. to be homogenized.

In parallel with the production of the above-described reaction product, 104.6 parts of dimethylethanolamine was added to 384 parts of half blocked tolylene diisocyanate modified with 2-ethylhexanol in another reaction vessel, the mixture was stirred at 80° C. for 1 hour, then 141.1 parts of 75% aqueous lactic acid was charged, further, 47.0 parts of ethylene glycol mono-n-butyl ether was mixed and the mixture was stirred for 30 minutes to manufacture a quaternization agent (solid content of 85%). Then, 620.46 parts of the quaternization agent was added to the previous reaction product and the mixture was kept at 85 to 95° C. until an acid value was 1, to obtain the resin solution (solid resin content of 56%) of a pigment dispersion resin (average molecular weight of 2200).

### Preparation Example 5

### Production of Pigment Dispersion Paste for Electrodeposition Coating Composition

A pigment paste (solid content of 59%) having composition shown in Table 1 below that contained the pigment dispersion resin obtained in Preparation Example 4 was dispersed at 40° C. using a sand mill until a particle size was 5 μm or less, to be prepared.

TABLE 1

| Composition | Compounding amount (parts by weight) |
|---|---|
| Pigment dispersion resin varnish | 53.6 |
| of Preparation Example 4 | |
| Titanium dioxide | 54.0 |
| Carbon black | 1.0 |
| Aluminum phosphomolybdate | 4.0 |
| Clay | 11.0 |
| Ion exchanged water | 46.4 |

### Preparation Example 6

### Production of Electrodeposition Coating Composition Used in Second Step

350 g (solid content) of the base resin obtained in Preparation Example 2 and 150 g (solid content) of the curing agent obtained in Preparation Example 3 were mixed and ethylene glycol mono-2-ethylhexyl ether was added so as to be 3% (15 g) for the solid content. Then, glacial acetic acid was added to neutralize so that a neutralization rate was 40.5%, ion exchanged water was added to slowly dilute it, and then, methyl isobutyl ketone was removed under reduced pressure so that the solid content was 36%. To 2000 g of the emulsion thus obtained, 460.0 g of the pigment dispersion paste containing various pigment obtained in Preparation Example 4, 2252 g of ion exchanged water and 1% by weight of dibutyltin oxide based on the solid resin content were added and mixed to prepare an electrodeposition coating composition with a solid content of 20.0% by weight.

The organic acid salt or inorganic acid salt of the rare earth metal was directly added to the coating composition, a portion of titanium dioxide in the pigment paste was replaced in other cases and respective electrodeposition coating compositions were prepared by adjusting addition amounts (% by weight) as metal shown in Tables 2 and 3 below.

### Examples 1 to 7

After a surface-untreated cold-rolled steel plate (JIS G3141, SPCC-SD) was defatted with SURFCLEANER SC-53 (manufactured by Nippon Paint Co., Ltd.) and rinsed with water, it was treated with electrolysis according to condition shown in Tables 2 and 3 as a cathode in each of the respective aqueous solutions for the first step shown in Tables 2 and 3 that were prepared by the process described in Preparation Example 1. The deposition amount of a crystalline continuous coating film was determined by quantifying the treated plate that was rinsed with water and dried after electrolysis treatment by fluorescence X-ray measurement. Then, the substrate treated with electrolysis was adequately rinsed with pure water, and after each of the respective electrodeposition coating compositions shown in Tables 2 and 3 was electrocoated at the coating condition of the same Tables so that the dry film thickness of the electrodeposition coating film at the electrodeposition step was 20μ, it was cured at 170° C. for 20 minutes to obtain a coating film.

### Comparative Example 1

Electrodeposition coating was carried out in the same manner as Examples 1 to 7 so that dry film thickness was 20μ, except that electrodeposition coating was carried out using the electrodeposition coating composition shown in Table 3 and coating condition using a plate treated with zinc phosphate that was obtained by treating a surface-untreated cold-rolled steel plate (JIS G3141, SPCC-SD) with SURFDINE SD 5000 (manufactured by Nippon Paint Co., Ltd.), and electrodeposition coating film was obtained.

### Examples 8 to 19 and Comparative Examples 2 to 6

After a surface-untreated cold-rolled steel plate (JIS G3141, SPCC-SD) was defatted with SURFCLEANER SC-53 (manufactured by Nippon Paint Co., Ltd.) and rinsed with water, it was treated with electrolysis according to condition shown in Tables 4 to 8 as a cathode in each of the respective aqueous solutions for the first step shown in the Tables 4 to 8 that were prepared by the process described in Preparation Example 1. Then, the substrate treated with electrolysis was adequately rinsed with pure water, and after each of the respective electrodeposition coating compositions shown in Tables 4 to 8 was electrocoated at the coating condition of the same Tables so that the dry film thickness of the electrodeposition coating film at the electrodeposition step was 20μ, it was cured at 170° C. for 20 minutes to obtain a coating film. The deposition amount of the crystalline continuous coating film was determined by quantifying the treated plate that was rinsed with water and dried after electrolysis treatment, by fluorescence X-ray measurement.

### Comparative Example 7

Electrodeposition coating was carried out in the same manner as Examples 8 to 19 and Comparative Examples 2 to 6 so that a dry film thickness was 20μ, except that after a surface-untreated cold-rolled steel plate (JIS G3141, SPCC-SD) was defatted with SURFCLEANER SC-53 (manufactured by Nippon Paint Co., Ltd.) and rinsed with water, the electrodeposition coating composition shown in Table 8 and coating condition were used without carrying out the first step, and an electrodeposition coating film was obtained.

### Comparative Example 8

Electrodeposition coating was carried out in the same manner as Comparative Example 7 so that dry film thickness was 20μ, except that the electrodeposition coating composition shown in Table 8 and coating condition were used using a plate treated with zinc phosphate that was obtained by a treating surface-untreated cold-rolled steel plate (JIS G3141, SPCC-SD) with SURFDINE SD 5000 (manufactured by Nippon Paint Co., Ltd.), and an electrodeposition coating film was obtained.

Anticorrosion property by a salt spray test (SST: Salt Splay Test), adhesion property by an electrolytic peeling test and coating film appearance as coating film test items were evaluated with respect to the coating films obtained and the result was shown in Tables 2 and 3. Test methods were as indicated below.

(1) Evaluation of Anticorrosion Property: Salt Spray Test Method

After cross cut for the electrodeposition coating plates after curing was carried out and the salt spray test was carried out for 1000 hours, the swelling width of rust at one side from the cut portion was then evaluated. Evaluation criteria were as indicated below.

### Evaluation Criteria

⊙: Peeling width was 3 mm or less.
◯: Peeling width was 3 mm to 4 mm.
Δ: Peeling width was 4 mm to 6 mm.
x: Peeling width was 6 mm or more.

### (Test Method)

(2) Evaluation of Adhesion Property: Electrolytic Peeling Test

After cut for the electrodeposition coating plates after curing was carried out and electrolysis for 72 hours was carried out at an electric current value of 0.1 mA, tape peeling was carried out and adhesion property was evaluated from a peeling width on both sides. Evaluation criteria were as below.

### Evaluation Criteria

⊙: Peeling width was 3 mm or less.
◯: Peeling width was 3 mm to 6 mm.
Δ: Peeling width was 6 mm to 10 mm.
x: Peeling width was 10 mm or more.

(3) Coating Film Appearance

The presence or absence of abnormality was visually judged. Evaluation criteria were as below.

### Evaluation Criteria

◯: No problem.
x: Poor appearance such as rough surface.

TABLE 2

| | | | Examples | | | |
|---|---|---|---|---|---|---|
| | | | 1 | 2 | 3 | 4 |
| First | Solution | Metal species | Ce | Ce | Ce | Nd |
| step | | % by weight | 0.05 | 0.1 | 0.2 | 0.5 |
| | | concentration | | | | |
| | | (converted to | | | | |
| | | metal) | | | | |
| | | Acid species of | Nitric | Nitric | Nitric | Nitric |
| | | salt compound | acid | acid | acid | acid |
| | | Conductivity | 2 | 3.5 | 5 | 9.5 |
| | | (mS/cm) | | | | |
| | Treatment condition | Electrolysis | 4 | 5 | 7 | 7 |
| | | voltage (V) | | | | |
| | | Time (sec) | 20 | 40 | 90 | 15 |
| | | Deposition amount | 2 | 3.5 | 47 | 13 |
| | | (mg/m²) | | | | |
| Second | Electrodeposition | Contained metal | Ce | Ce | Ce | Nd |
| step | coating | species | | | | |
| | | Acid species of | Acetic | Acetic | Formic | Acetic |
| | | salt compound | acid | acid | acid | acid |
| | | % by weight | 0.01 | 0.01 | 0.03 | 0.05 |
| | | concentration | | | | |
| | | (converted to | | | | |
| | | metal) | | | | |
| | Coating condition | Voltage (V) | 180 | 180 | 180 | 180 |
| | | Time (sec) | 150 | 150 | 150 | 150 |
| | | Film thickness of | 3 | 9 | 100 | 19 |
| | | composite | | | | |
| | | chemical | | | | |
| | | conversion coating | | | | |
| | | film (nm) | | | | |
| | | Weight of | 3 | 5 | 52 | 15 |
| | | composite | | | | |
| | | chemical | | | | |
| | | conversion coating | | | | |
| | | film (mg/m²) | | | | |
| | | Film thickness of | 20 | 20 | 20 | 20 |
| | | coating film (μ) | | | | |

| | | | | | |
|---|---|---|---|---|---|
| Evaluation result | Anticorrosion | ◯ | ⊙ | ⊙ | ⊙ |
| | property (SST) | | | | |
| | Adhesion property | ◯ | ⊙ | ⊙ | ⊙ |
| | Coating film | ◯ | ◯ | ◯ | ◯ |
| | appearance | | | | |

TABLE 3

| | | | | | | Comparative |
|---|---|---|---|---|---|---|
| | | | Examples | | | Examples |
| | | | 5 | 6 | 7 | 1 |
| First | Solution | Metal species | Y | Sm | Pr | Plate treated |
| step | | | | | | with zinc |
| | | | | | | phosphate |
| | | % by weight | 0.5 | 0.5 | 0.5 | — |
| | | concentration | | | | |
| | | (converted to metal) | | | | |
| | | Acid species of salt | Nitric | Nitric | Nitric | — |
| | | compound | acid | acid | acid | |
| | | Conductivity (mS/cm) | 9 | 8.7 | 9.2 | — |
| | Treatment | Electrolysis voltage | 10 | 7 | 5 | — |
| | condition | (V) | | | | |
| | | Time (sec) | 10 | 20 | 30 | — |
| | | Deposition amount | 3 | 18 | 10 | — |
| | | (mg/m²) | | | | |
| Second | Electrodeposition | Contained metal | Y | Sm | Pr | Ce |
| step | coating | species | | | | |
| | | Acid species of salt | Acetic | Acetic | Acetic | Acetic acid |
| | | compound | acid | acid | acid | |
| | | % by weight | 0.06 | 0.05 | 0.05 | 0.01 |
| | | concentration | | | | |
| | | (converted to metal) | | | | |
| | Coating condition | Voltage (V) | 180 | 180 | 180 | 180 |
| | | Time (sec) | 150 | 150 | 150 | 150 |
| | | Film thickness of | 7 | 26 | 17 | 1000* |
| | | composite chemical | | | | |
| | | conversion coating | | | | |
| | | film (nm) | | | | |
| | | Weight of composite | 4 | 20 | 12 | 2500* |
| | | chemical conversion | | | | |
| | | coating film (mg/m²) | | | | |
| | | Film thickness of | 20 | 20 | 20 | 20 |
| | | coating film (μ) | | | | |

| | | | | | |
|---|---|---|---|---|---|
| Evaluation result | Anticorrosion | ◯ | ◯ | ◯ | ⊙ |
| | property (SST) | | | | |
| | Adhesion property | ◯ | ◯ | ◯ | ⊙ |
| | Coating film | ◯ | ◯ | ◯ | ◯ |
| | appearance | | | | |

*A film thickness of a coating film obtained by zinc phosphate treatment and a weight of a coating film

As cleared from the result of Tables 2 and 3, it was observed that with respect to the adhesion property by electrolytic peeling test, anticorrosion property by salt spray test (SST) and coating film appearance as coating film test items, the composite chemical conversion coating films of the present invention of Examples 1 to 7 and the multiple layered coating films containing its coating film were nearly equal to Comparative Example 1 and all was superior nevertheless these film thickness and the weight of coating film of the Examples are about 1/100 in comparison with the plate treated with zinc phosphate of Comparative Example 1.

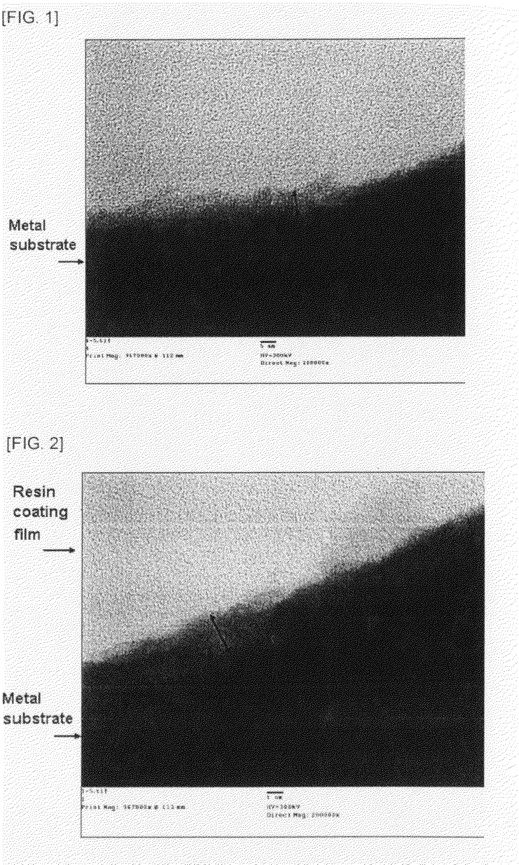

In one aspect of the multiple layered coating film of the present invention in which the rare earth metal is Ce as a typical example, the sectional observation of a film by a transmission electron microscope (TEM) was carried out and a distribution state was analyzed by the analysis of configuration and a film thickness and elemental analysis by energy dispersion type X-ray analysis (EDX). The analysis result was shown in FIGS. 1 to 4. As shown in FIG. 4, continuousness and crystallinity were confirmed by the sectional observation of a deposited coating film from a high magnification photo (magnified photo) of the substrate surface portion of the multiple layered coating film after the first and second steps of the present invention by TEM. Further, as shown in FIG. 3, the improvement of denseness of an element in the composite chemical conversion coating film of the present invention was confirmed from the TEM photo of the substrate surface portion after the first step of the present invention and EDX observation result (upper stage) and the TEM and EDX observation result (lower stage) of the multiple layered coating film after the first and second steps. Further, similar results were observed also in Y, Nd and Pr metal salts other than Ce.

TABLE 4

| | | | Examples | | | |
|---|---|---|---|---|---|---|
| | | | 8 | 9 | 10 | 11 |
| First | Solution | Metal species | Ce | Ce | Ce | Ce |
| step | | % by weight | 0.05 | 0.1 | 0.2 | 0.5 |
| | | concentration | | | | |
| | | (converted to | | | | |
| | | metal) | | | | |
| | | Acid species of | Nitric acid | Nitric acid | Nitric acid | Nitric acid |
| | | salt compound | | | | |
| | | Conductivity | 2 | 3.5 | 5 | 10 |
| | | (mS/cm) | | | | |
| | Treatment | Electrolysis | 5 | 5 | 10 | 7 |
| | condition | voltage (V) | | | | |
| | | Time (sec) | 20 | 60 | 20 | 30 |
| | | Deposition amount | 2 | 6 | 7 | 10 |
| | | (mg/m²) | | | | |
| Second | Electrodeposition | Contained metal | Ce | Ce | Ce | Ce |
| step | coating | species | | | | |
| | | Acid species of | Acetic acid | Acetic acid | Formic | Sulfamic |
| | | salt compound | | | acid | acid |
| | | % by weight | 0.01 | 0.01 | 0.03 | 0.08 |
| | | concentration | | | | |
| | | (converted to | | | | |
| | | metal) | | | | |
| | Coating condition | Voltage (V) | 180 | 180 | 180 | 180 |
| | | Time (sec) | 150 | 150 | 150 | 150 |

| | | | | | |
|---|---|---|---|---|---|
| Evaluation result | Anticorrosion | ◯ | ⊙ | ⊙ | ⊙ |
| | property (SST) | | | | |
| | Adhesion property | ◯ | ⊙ | ⊙ | ⊙ |
| | Coating film | ◯ | ◯ | ◯ | ◯ |
| | appearance | | | | |

TABLE 5

| | | | Examples | | | |
|---|---|---|---|---|---|---|
| | | | 12 | 13 | 14 | 15 |
| First | Solution | Metal species | Ce | Ce | Ce | Y |
| step | | % by weight | 0.3 | 1 | 4 | 0.5 |
| | | concentration | | | | |
| | | (converted to | | | | |
| | | metal) | | | | |
| | | Acid species of | Nitric | Nitric acid | Nitric acid | Nitric |
| | | salt compound | acid | | | acid |
| | | Conductivity | 6.5 | 20 | 80 | 9 |
| | | (mS/cm) | | | | |
| | Treatment | Electrolysis | 7 | 3 | 4 | 10 |
| | condition | voltage (V) | | | | |
| | | Time (sec) | 20 | 90 | 200 | 15 |
| | | Deposition | 7 | 50 | 90 | 8 |
| | | amount (mg/m²) | | | | |
| Second | Electrodeposition | Contained | Ce | Ce | Ce | Y |
| step | coating | metal species | | | | |
| | | Acid species of | Lactic | Hypophosphorous | Sulfamic | Acetic |
| | | salt compound | acid | acid | acid | acid |
| | | % by weight | 0.04 | 0.1 | 0.15 | 0.06 |
| | | concentration | | | | |
| | | (converted to | | | | |
| | | metal) | | | | |
| | Coating condition | Voltage (V) | 180 | 180 | 180 | 180 |
| | | Time (sec) | 150 | 150 | 150 | 150 |

| | | | | | |
|---|---|---|---|---|---|
| Evaluation result | Anticorrosion | ⊙ | ◯ | ◯ | ◯ |
| | property (SST) | | | | |
| | Adhesion | ⊙ | ◯ | ◯ | ◯ |
| | property | | | | |
| | Coating film | ◯ | ◯ | ◯ | ◯ |
| | appearance | | | | |

TABLE 6

| | | | Examples | | | |
|---|---|---|---|---|---|---|
| | | | 16 | 17 | 18 | 19 |
| First | Solution | Metal species | Nd | Ce | Sm | Pr |
| step | | % by weight | 0.5 | 0.1 | 0.2 | 0.5 |
| | | concentration | | | | |
| | | (converted to | | | | |
| | | metal) | | | | |
| | | Acid species of | Nitric acid | Nitric acid | Nitric acid | Nitric acid |
| | | salt compound | | | | |
| | | Conductivity | 9.5 | 5 | 4.7 | 9.2 |
| | | (mS/cm) | | | | |
| | Treatment | Electrolysis | 10 | 5 | 7 | 10 |
| | condition | voltage (V) | | | | |
| | | Time (sec) | 15 | 60 | 30 | 15 |
| | | Deposition | 8 | 6 | 3 | 8 |
| | | amount (mg/m²) | | | | |
| Second | Electrodeposition | Contained | Nd | Ce | Sm | Pr |
| step | coating | metal species | | | | |
| | | Acid species of | Acetic acid | Acetic acid | Acetic acid | Acetic acid |
| | | salt compound | | | | |
| | | % by weight | 0.05 | 0.005 | 0.05 | 0.05 |
| | | concentration | | | | |
| | | (converted to | | | | |
| | | metal) | | | | |
| | Coating condition | Voltage (V) | 180 | 180 | 180 | 180 |
| | | Time (sec) | 150 | 150 | 150 | 150 |

| | | | | | |
|---|---|---|---|---|---|
| Evaluation result | Anticorrosion | ⊙ | ◯ | ◯ | ◯ |
| | property (SST) | | | | |
| | Adhesion | ⊙ | ◯ | ◯ | ◯ |
| | property | | | | |
| | Coating film | ◯ | ◯ | ◯ | ◯ |
| | appearance | | | | |

TABLE 7

| | | | Comparative Examples | | | |
|---|---|---|---|---|---|---|
| | | | 2 | 3 | 4 | 5 |
| First | Solution | Metal species | Ce | Ce | Ce | Ce |
| step | | % by weight | 0.05 | 0.05 | 0.05 | 0.1 |
| | | concentration | | | | |
| | | (converted to | | | | |
| | | metal) | | | | |
| | | Acid species of | Nitric acid | Nitric acid | Nitric acid | Sulfuric acid |
| | | salt compound | | | | |
| | | Conductivity | 2 | 2 | 2 | 4 |
| | | (mS/cm) | | | | |
| | Treatment | Electrolysis | 0.5 | 25 | 5 | 5 |
| | condition | voltage (V) | | | | |
| | | Time (sec) | 60 | 30 | 5 | 60 |
| | | Deposition | 0.2 | 0.2 | 0.8 | 8 |
| | | amount (mg/m²) | | | | |
| Second | Electrodeposition | Contained | Ce | Ce | Ce | Ce |
| step | coating | metal species | | | | |
| | | Acid species of | Acetic | Acetic | Acetic | Acetic acid |
| | | salt compound | acid | acid | acid | |
| | | % by weight | 0.05 | 0.05 | 0.05 | 0.01 |
| | | concentration | | | | |
| | | (converted to | | | | |
| | | metal) | | | | |
| | Coating condition | Voltage (V) | 180 | 180 | 180 | 180 |
| | | Time (sec) | 150 | 150 | 150 | 150 |

| | | | | | |
|---|---|---|---|---|---|
| Evaluation result | Anticorrosion | X | X | Δ | X |
| | property (SST) | | | | |
| | Adhesion | X | X | Δ | X |
| | property | | | | |
| | Coating film | ◯ | ◯ | ◯ | ◯ |
| | appearance | | | | |

TABLE 8

| | | | Comparative Examples | | |
|---|---|---|---|---|---|
| | | | | | 8 |
| | | | | | Plate treated |
| | | | | 7 | with zinc |
| | | | 6 | Untreated plate | phosphate |
| First | Solution | Metal species | Ce | — | — |
| step | | % by weight | 0.1 | — | — |
| | | concentration | | | |
| | | (converted to | | | |
| | | metal) | | | |
| | | Acid species of | Nitric acid | — | — |
| | | salt compound | | | |
| | | Conductivity | 5 | — | — |
| | | (mS/cm) | | | |
| | Treatment | Electrolysis | 5 | — | — |
| | condition | voltage (V) | | | |
| | | Time (sec) | 60 | — | — |
| | | Deposition | 6 | — | — |
| | | amount (mg/m²) | | | |
| Second | Electrodeposition | Contained | None | Ce | Ce |
| step | coating | metal species | | | |
| | | Acid species of | None | Acetic acid | Acetic acid |
| | | salt compound | | | |
| | | % by weight | None | 0.01 | 0.01 |
| | | concentration | | | |
| | | (converted to | | | |
| | | metal) | | | |
| | Coating condition | Voltage (V) | 180 | 180 | 180 |
| | | Time (sec) | 150 | 150 | 150 |

| | | | | |
|---|---|---|---|---|
| Evaluation result | Anticorrosion | Δ | X | ⊙ |
| | property (SST) | | | |
| | Adhesion | Δ | X | ⊙ |
| | property | | | |
| | Coating film | ◯ | ◯ | ◯ |
| | appearance | | | |

As cleared from the results of Tables 4 to 8, it was observed that with respect to anticorrosion property by the salt spray test (SST), the adhesion property by the electrolytic peeling test and coating film appearance as coating film test items, the coating films formed by using the process for forming a multiple layered coating film of the present invention of Examples 8 to 19 were in an equal level to the plate treated with zinc phosphate of Comparative Example 8 and all was superior.

The coating films of Comparative Examples 2 to 4 in which the deposition amount of the crystalline continuous coating film at the first step was small were very poor in anticorrosion property and adhesion property, because substrate adhesion property by a formed coating film was lowered.

Since the coating film of Comparative Example 5 using an aqueous solution containing the sulfate of cerium (Ce) at the first step was not nitrate, anticorrosion property and adhesion property were very poor in the same state as an untreated plate to which pretreatment was not carried out.

The coating film of Comparative Example 6 not containing the rare earth metal compound in an electrodeposition coating composition was poor in anticorrosion property and adhesion property, because substrate adhesion property by a formed coating film was lowered.

### INDUSTRIAL APPLICABILITY

The composite chemical conversion coating film of the present invention is useful as the multiple layered coating film containing a coating substrate treatment (pretreatment) coating film and an electrodeposition coating film that are suitable for a metal material, in particular, an untreated cold-rolled steel plate. The composite chemical conversion coating film of the present invention has superior substrate adhesion property, corrosion resistance (anticorrosion property) and coating film appearance and can be utilized for use in an automobile.

Further, the process for forming a multiple layered coating film of the present invention is useful as a process for forming a multiple layered coating film that is suitable for a metal material, in particular, an untreated cold-rolled steel plate. A multiple layered coating film obtained by the process for forming a multiple layered coating film of the present invention has superior substrate adhesion property and corrosion resistance (anticorrosion property) and can be utilized for use in an automobile.

1. A crystalline continuous coating film, comprising a rare earth metal compound that is formed on a metal substrate.

2. A composite chemical conversion coating film, wherein an amorphous rare earth metal compound exists on a crystalline continuous coating film comprising a rare earth metal compound that is formed on a metal substrate.

3. A composite chemical conversion coating film, comprising a crystalline continuous coating film with a film thickness of 3 to 200 nm which is composed of a rare earth metal compound, which is formed on a metal substrate.

4. A composite chemical conversion coating film, comprising a crystalline continuous coating film which is composed of a rare earth metal compound and which has a coating film amount of 1 mg/m² at lower limit and 110 mg/m² at upper limit, which is formed on a metal substrate.

5. The composite chemical conversion coating film according to claim 2, wherein the crystalline continuous coating film comprises at least one of rare earth metal compound selected from the group consisting of cerium (Ce), yttrium (Y), neodymium (Nd), samarium (Sm) and praseodymium (Pr).

6. A multiple layered coating film, wherein an organic resin coating film with a film thickness of 5 to 50 μm is coated on the composite chemical conversion coating film according to claim 2.

7. The multiple layered coating film according to claim 6, wherein the organic resin coating film is an electrodeposition cured coating film made from a cation modified epoxy resin and a blocked isocyanate curing agent as main components.

8. The multiple layered coating film according to claim 7, wherein the organic resin coating film is an electrodeposition cured coating film further containing a pigment.

9. A process for forming a multiple layered coating film, comprising the first step of immersing an untreated metal substrate in an aqueous solution containing (A) nitrate of rare earth metal, and forming a crystalline continuous coating film according to claim 4 comprising a rare earth metal compound with a deposition amount of 1 mg/m² at lower limit and 110 mg/m² at upper limit by cathode electrolysis, and
the second step of coating an electrodeposition coating composition containing (B) organic acid or inorganic acid salt of a rare earth metal by cathode electrodeposition.

10. The process for forming multiple layered coating film according to claim 9, wherein (B) the organic acid or inorganic acid salt of a rare earth metal is an organic acid or inorganic acid salt compound comprising at least one selected from the group consisting of acetic acid, formic acid, lactic acid, sulfamic acid and hypophosphorous acid.

11. The process for forming a multiple layered coating film according to claim 9, wherein (A) the nitrate of a rare earth metal and (B) the organic acid or inorganic acid salt of a rare earth metal are compounds comprising at least one of rare earth metal selected from the group consisting of cerium (Ce), yttrium (Y), neodymium (Nd), samarium (Sm) and praseodymium (Pr).

12. The process for forming a multiple layered coating film according to claim 9, wherein an aqueous solution containing (A) the nitrate of a rare earth metal compound comprises 0.05 to 5% by weight of the rare earth metal converted to the rare earth metal, and as treatment conditions of the first step, a voltage of 1 to 20 V is applied using an untreated metal substrate immersed in the aqueous solution as a cathode, and a power distribution time is 10 to 300 seconds.

13. The process for forming a multiple layered coating film according to claim 9, wherein the composite chemical conversion coating film comprising (B) the organic acid or inorganic acid salt of a rare earth metal comprises of a rare earth metal compound in an amount of 0.005 to 2% by weight converted to the rare earth metal.

14. The composite chemical conversion coating film according to claim 3, wherein the crystalline continuous coating film comprises at least one of rare earth metal compound selected from the group consisting of cerium (Ce), yttrium (Y), neodymium (Nd), samarium (Sm) and praseodymium (Pr).

15. The composite chemical conversion coating film according to claim 4, wherein the crystalline continuous coating film comprises at least one of rare earth metal compound selected from the group consisting of cerium (Ce), yttrium (Y), neodymium (Nd), samarium (Sm) and praseodymium (Pr).

16. A multiple layered coating film, wherein an organic resin coating film with a film thickness of 5 to 50 μm is coated on the composite chemical conversion coating film according to claim 3.

17. A multiple layered coating film, wherein an organic resin coating film with a film thickness of 5 to 50 μm is coated on the composite chemical conversion coating film according to claim 4.

18. A multiple layered coating film, wherein an organic resin coating film with a film thickness of 5 to 50 μm is coated on the composite chemical conversion coating film according to claim 5.

19. The process for forming a multiple layered coating film according to claim 10, wherein (A) the nitrate of a rare earth metal and (B) the organic acid or inorganic acid salt of a rare earth metal are compounds comprising at least one of rare earth metal selected from the group consisting of cerium (Ce), yttrium (Y), neodymium (Nd), samarium (Sm) and praseodymium (Pr).

20. The process for forming a multiple layered coating film according to claim 10, wherein an aqueous solution containing (A) the nitrate of a rare earth metal compound comprises 0.05 to 5% by weight of the rare earth metal converted to the rare earth metal, and as treatment conditions of the first step, a voltage of 1 to 20 V is applied using an untreated metal substrate immersed in the aqueous solution as a cathode, and a power distribution time is 10 to 300 seconds.

21. The process for forming a multiple layered coating film according to claim 11, wherein an aqueous solution containing (A) the nitrate of a rare earth metal compound comprises 0.05 to 5% by weight of the rare earth metal converted to the rare earth metal, and as treatment conditions of the first step, a voltage of 1 to 20 V is applied using an untreated metal substrate immersed in the aqueous solution as a cathode, and a power distribution time is 10 to 300 seconds.

22. The process for forming a multiple layered coating film according to claim 10, wherein the composite chemical conversion coating film comprising (B) the organic acid or inorganic acid salt of a rare earth metal comprises of a rare earth metal compound in an amount of 0.005 to 2% by weight converted to the rare earth metal.

23. The process for forming a multiple layered coating film according to claim 11, wherein the composite chemical conversion coating film comprising (B) the organic acid or inorganic acid salt of a rare earth metal comprises of a rare earth metal compound in an amount of 0.005 to 2% by weight converted to the rare earth metal.

24. The process for forming a multiple layered coating film according to claim 12, wherein the composite chemical conversion coating film comprising (B) the organic acid or inorganic acid salt of a rare earth metal comprises of a rare earth metal compound in an amount of 0.005 to 2% by weight converted to the rare earth metal.
